(19) United States
(12) Patent Application Publication
(10) Pub. No.: US 2021/0142751 A1
(43) Pub. Date: May 13, 2021

(54) PIXEL DRIVING CIRCUIT AND DISPLAY DEVICE

(71) Applicant: HKC CORPORATION LIMITED, Shenzhen (CN)

(72) Inventor: Jianfeng SHAN, Shenzhen (CN)

(73) Assignee: HKC CORPORATION LIMITED, Shenzhen (CN)

(21) Appl. No.: 17/043,701

(22) PCT Filed: Dec. 14, 2018
(86) PCT No.: PCT/CN2018/121234

§ 371 Date: Sep. 30, 2020

(30) Foreign Application Priority Data
Nov. 13, 2018 (CN) 201821869211.9

(51) Int. Cl. G09G 3/36

(52) U.S. Cl. CPC G09G 3/3648; G09G 3/3674; G09G 2320/0252; G09G 2300/0443; G09G 3/3685

(57) ABSTRACT

A pixel driving circuit and a display device are provided. The pixel driving circuit includes a plurality of sub-pixels, at least 3M scan wires, at least two data wires, and a driving circuit. At least three consecutive sub-pixels in a same column constitute one pixel, each two rows of pixels form one group, and each of the sub-pixels includes M domain areas. In each group of the pixels, ith domain areas of the sub-pixels with a same color are connected to a same scan wire of the at least 3M scan wires, each column of the sub-pixels is correspondingly connected to the at least two data wires, M≥2, 1≤i≤M, and M and i are integers. A charging rate of the each of the sub-pixels are improved through the pixel driving circuit.

This application claims priority to Chinese Patent Application No. 2018218692119, filed to China's SIPO on Nov. 13, 2018 and entitled “pixel driving circuit and display device”, the content of which is incorporated herein by reference in its entirety.

### FIELD OF THE INVENTION

The present application relates to the field of display technologies, and particularly to a pixel driving circuit and a display device.

### BACKGROUND OF THE INVENTION

The statements in this part only provide background information related to this application, and do not necessarily constitute prior art. TFT-LCD (Thin Film Transistor Liquid Crystal Display) is an electronic component commonly used in the current industrial technology. According to a working method of the TFT-LCD in the traditional technology, the TFT-LCD can display a complete frame through different pixel driving methods. The display panel includes a plurality of pixels, and the pixels in the display panel are scanned cyclically through a driving signal to realize display of a complete image/video of the display panel at a high frame rate, and the TFT-LCD can be in a normal and stable working condition when driven by the driving signal.

With the rapid development of display technologies, the frame in the display panel has developed in a direction of widescreen and large size. In the traditional technology, the frame of the display panel can be displayed with a large viewing angle, thereby bringing a better real experience to the user. However, since different pixels in the display panel need to be kept charged during normal operation, the charging signals introduced to the different pixels are not the same during the driving process of the display panel, such that there are problems that the charging rate of the pixels of the display panel is insufficient, the large-angle display effect of the frames in the display screen is not good, and the scanning driving cost of the display panel is high, thereby the user experience is poor.

### SUMMARY OF THE INVENTION

An object of the present application is to provide a pixel driving circuit and a display device, including but not limited to solving the problems in the exemplary technologies, i.e., the large-angle display effect of the display panel is poor, the charging rates of the pixels in the display panel are insufficient, and the scanning and driving cost of the pixels is relatively high, therefore the user's visual experience is poor.

The technical solutions adopted by embodiments of the present application include a pixel driving circuit, which includes:

a plurality of sub-pixels regularly arranged into at least six rows and at least one column, wherein at least three consecutive sub-pixels located in the same column constitute one pixel, each two rows of pixels form one group, and each of the sub-pixels comprises M domains area;

at least 3M scan wires, wherein each row of the sub-pixels is correspondingly connected to M scan wires, and ith domain areas of the sub-pixels with the same color in each group of pixels are connected to the same scan wire;

at least two data wires, wherein each column of the sub-pixels is correspondingly connected to two data wires, any two adjacent domain areas in a row direction are connected to the same data wire, and the any two adjacent domain areas in the row direction are located in different sub-pixels;

and a driving circuit connected to the scan wires and the data wires, wherein the driving circuit is configured to output a scan signal through the scan wire to sequentially control each of the sub-pixels in the same row to turn on, and further configured to output a data driving signal through the data wire to charge the sub-pixels corresponding to the data wire, so that polarities of any two adjacent domain areas in the same sub-pixel are different;

wherein M≥2, 1≤i≤M, and M and i are integers.

Another purpose of the present application is aimed to provide a pixel driving circuit, which includes:

a plurality of sub-pixels regularly arranged into at least six rows and at least one column, wherein at least three consecutive sub-pixels located in the same column constitute one pixel, each two rows of pixels form one group, and each of the sub-pixels comprises M domains area;

at least 3M scan wires, wherein each row of the sub-pixels is correspondingly connected to M scan wires, and ith domain areas of the sub-pixels with the same color in each group of pixels are connected to the same scan wire;

at least two data wires, wherein each column of the sub-pixels is correspondingly connected to two data wires, any two adjacent domain areas in a row direction are connected to the same data wire, and the any two adjacent domain areas in the row direction are located in different sub-pixels;

and

a driving circuit connected to the scan wires and the data wires, wherein the driving circuit is configured to output a scan signal through the scan wire to sequentially control each of the sub-pixels in the same row to turn on, and further configured to output a data driving signal through the data wire to charge the sub-pixels corresponding to the data wire, so that polarities of any two adjacent domain areas in the same sub-pixel are different;

wherein polarities of any two adjacent domain areas in the row direction are the same, and the any two adjacent domain areas in the row direction are located in different sub-pixels;

wherein any two adjacent domain areas in the row direction are connected to the same scan wire, and the any two adjacent domain areas in the row direction are located in different sub-pixels;

wherein a first domain area and a Mth domain area in the same sub-pixel are connected to different scan wires, and the first domain area and the Mth domain area in the same sub-pixel are connected to different data wires;

wherein M≥2, 1≤i≤M, and M and i are integers.

Another purpose of the present application is aimed to provide a display device, which includes a pixel driving circuit and a display panel, wherein the pixel driving circuit is electrically connected to the display panel, and a frame display state of the display panel is changed by the pixel driving circuit; wherein the pixel driving circuit includes:

a plurality of sub-pixels regularly arranged into at least six rows and at least one column, wherein at least three consecutive sub-pixels located in the same column constitute one pixel, each two rows of pixels form one group, and each of the sub-pixels comprises M domains area;

at least 3M scan wires, wherein each row of the sub-pixels is correspondingly connected to M scan wires, and ith domain areas of the sub-pixels with the same color in each group of pixels are connected to the same scan wire;

at least two data wires, wherein each column of the sub-pixels is correspondingly connected to two data wires, any two adjacent domain areas in a row direction are connected to the same data wire, and the any two adjacent domain areas in the row direction are located in different sub-pixels;

and a driving circuit connected to the scan wires and the data wires, wherein the driving circuit is configured to output a scan signal through the scan wire to sequentially control each of the sub-pixels in the same row to turn on, and further configured to output a data driving signal through the data wire to charge the sub-pixels corresponding to the data wire, so that polarities of any two adjacent domain areas in the same sub-pixel are different;

wherein M≥2, 1≤i≤M, and M and i are integers.

In the pixel driving circuit provided by the embodiments of the present application, the number of scan wires is greatly reduced, and the sub-pixels with the same color can be controlled by the same scan signal to present complete and clear frames, and the scanning and driving cost of the pixel driving circuit is reduced. Therefore, in the present application, through utilizing the arrangement and distribution features of the domain areas of the sub-pixels in the horizontal direction and the vertical direction, the same data driving signal is introduced into adjacent domain areas of different sub-pixels in the row direction to improve the charging rate of each of the sub-pixels of the display panel, thus the display quality of the large-angle frames in the display panel is better, the scanning and driving cost of the plurality of the sub-pixels of the display panel is lower, and the user's visual experience is better. In the pixel driving circuit in the embodiments of the present application, the charging rates of the plurality of sub-pixels and the frame display effect of each of the sub-pixels are evenly improved, the frames of the display panel has a higher sense of reality, and the pixel driving circuit has an extremely wide application range.

### DESCRIPTION OF THE DRAWINGS

In order to more clearly illustrate the technical solutions in the embodiments of the present application, the drawings required to be used in the description of the embodiments or exemplary technologies are briefly introduced below. Obviously, the accompanying drawings in the following description are only some embodiments of the present application, and other drawings may be obtained without creative work by those of ordinary skill in the art based on these drawings.

FIG. 1 is a basic frame diagram of the pixel driving circuit provided by an embodiment of the present application.

FIG. 2 is a structural diagram of the pixel driving circuit provided by an embodiment of the present application.

FIG. 3 is a structural diagram of another pixel driving circuit provided by an embodiment of the present application.

FIG. 4 is a structural diagram of yet another pixel driving circuit provided by an embodiment of the present application.

FIG. 5 is a structural diagram of the display device provided by an embodiment of the present application.

### DETAILED EMBODIMENTS

In order to make the purpose, technical solutions, and advantages of this application clearer, this application will be further described in detail with reference to the accompanying drawings and embodiments. It should be understood that the specific embodiments described here are only used to explain the present application, and are not used to limit the present application.

It should be noted that when a circuit is referred to as “being fixed on” or “being arranged on” another circuit, it can be directly on said another circuit or indirectly on said another circuit. When a circuit is referred to as “being connected to” another circuit, it can be directly or indirectly connected to said another circuit. The orientations or position relationships indicated by the terms “upper”, “lower”, “left”, “right”, etc. are based on the orientations or position relationships as shown in the drawings, and are only for ease of description, but are not used to indicate or imply that a designated device or element must have a specific orientation or be constructed and operated in a specific orientation, and therefore cannot be construed as a limitation of the present application. For those of ordinary skill in the art, the specific meanings of the above terms can be understood according to specific conditions. The terms “first” and “second” are only used for ease of description, and cannot be understood as indicating or implying relative importance or implicitly indicating the number of a designated technical feature. The meaning of “plurality” means two or more, unless otherwise specifically defined.

In order to illustrate the technical solutions described in the present application, detailed descriptions are given below in conjunction with specific drawings and embodiments.

As an example, the term “one row” mentioned in the present application refers to a plurality of objects arranged in sequence in the horizontal direction, the term “one column” mentioned in the present application refers to a plurality of objects arranged in sequence in the vertical direction, and the row direction refers to the horizontal direction, and the column direction refers to the vertical direction.

FIG. 1 shows a basic framework of the pixel driving circuit provided by an embodiment of the present application. For ease of description, only parts related to the embodiment of the present application are shown, which are detailed as follows.

As shown in FIG. 1, the pixel driving circuit includes a plurality of sub-pixels, at least 3M scan wires G, at least two data wires D, and a driving circuit 40.

Regarding the plurality of sub-pixels, the plurality of sub-pixels are regularly arranged into at least six rows and at least one column, at least three consecutive sub-pixels located in the same column constitute one pixel, each two rows of pixels constitute one group, and each sub-pixel includes M domain areas.

Exemplarily, in the pixel driving circuit as shown in FIG. 1, the sub-pixels are the smallest color display components, and a light source of corresponding color may be displayed through driving each sub-pixel, where the sub-pixels are restricted by intersections of the data wires D and the scan wires G. One group of pixels includes two rows of pixels, for example, one group of pixels 30 in FIG. 1 includes two rows of pixels 301 and 302, and each sub-pixel includes a plurality of domain areas, for example, each sub-pixel includes 2 domain areas.

In this embodiment, the sub-pixels in the pixel driving circuit are arranged in an array both in the vertical direction and the horizontal direction, and each sub-pixel is connected to the data wire D and the scan wire G. The data wire D is configured to transmit a data driving signal, and a light-emitting state of each sub-pixel may be controlled by the data driving signal. The scan wire G is configured to transmit a scanning signal, and an on state or an off state of each sub-pixel may be controlled by the scanning signal, and the scanning signal includes control information for turning on turning off the sub-pixel. Therefore, in this embodiment, the scanning signal and the data driving signal can be simultaneously introduced to each of the sub-pixels, the charging state of each sub-pixel may be controlled by the scanning signal and the data driving signal, and each sub-pixel may be driven by the data driving signal to display corresponding frame/video. When the plurality of sub-pixels in the pixel driving circuit work together, the plurality of sub-pixels in the display panel may combine different colors to present images/videos of various colors and brightness, and thus the sub-pixels have good controllability in this embodiment, and the display panel can display normal frames under the driving of the scanning signal and the data driving signal.

As an alternative implementation, FIG. 2 shows a structure of the pixel driving circuit provided in an embodiment. As shown in FIG. 2, there are at least 3M scan wires G, and each row of sub-pixels corresponds to and is connected to M scan wires G. In each group of pixels, the ith domain areas of the sub-pixels with the same color are connected to the same scan wire G.

In this embodiment, the plurality of scan wires are arranged in an array in the column direction, and M scanning signals may be introduced to each row of sub-pixels. The plurality of sub-pixels may be driven by the scanning signals to be at different working states to display different frames with different colors. At the same time, the corresponding display domain areas of the sub-pixels with the same color in each group of pixels share one scan wire G, such that the pixel driving circuit in this embodiment greatly saves the number of scan wires and simplifies the spatial layout structure of the scan wires G, therefore the pixel driving circuit has a lower cost of scanning and driving.

Exemplarily, in one group of pixels 30 of the pixel driving circuit as shown in FIG. 2, the first row of sub-pixels 201 and the fourth row of sub-pixels 204 have the same color, then the corresponding domain areas of the first row of sub-pixels 201 and the fourth row of sub-pixels 204 are connected to the same scan wire, so in this embodiment one scanning signal can simultaneously drive the sub-pixels of the two rows into the working state, thereby greatly improving the scanning and driving efficiencies of the pixel driving circuit, and simplifying the layout structure of the pixel driving circuit.

Regarding the at least two data wires D, each column of sub-pixels corresponds to and is connected to two data wires D. In the row direction, any two adjacent domain areas are connected to the same data wire D, and said any two adjacent domain areas are located in different sub-pixels.

The image data may be transmitted to every domain area through the data driving signal on the data wire D can transmit, so as to drive each domain area to display the corresponding light source. In this embodiment, in the row direction, the same data driving signal is introduced to any two adjacent display domain areas in different sub-pixels respectively, and the image display state of the display domain areas in the two sub-pixels may be simultaneously controlled through the data driving signal, so that different sub-pixels in this embodiment can work in coordination. The plurality of sub-pixels cooperate with each other to display a complete image/video, thereby improving the controllability of the plurality of sub-pixels.

As an alternative implementation, at least one data wire D is provided between any two adjacent rows of sub-pixels.

As an alternative implementation, at least one scan wire G is provided between any two adjacent columns of sub-pixels.

In this embodiment, different data wires D transmit different data driving signals, and different scan wires G transmit different scanning signals, and then each sub-pixel may be in a corresponding working state through the data driving signal and the scanning signal. In this embodiment, there is at least one data wire D between two adjacent sub-pixels in the horizontal direction, and at least one scan wire G between two adjacent sub-pixels in the vertical direction. The pixel driving circuit can combine the data wire D and the scan wire G to realize the scanning and driving of the sub-pixels, and implement the charging process of the sub-pixels through the data driving signal and the scanning signal based on an overall display requirement of frames in the display panel, so as to adjust the charging rate of each of the sub-pixels.

Regarding the driving circuit 40, the driving circuit 40 is connected to the scan wire G and the data wire D, and outputs the scanning signal through the scan wire G, and sequentially controls each of the sub-pixels in the same row to turn on; the driving circuit 40 also outputs the data driving signal through the data wire D, and charges the sub-pixels corresponding to the data wire D, so that the polarities of any two adjacent domain areas in the same sub-pixel are different; here M, and M and i are integers.

Referring to the above embodiment of FIG. 2, since any two adjacent domain areas in each of the sub-pixels have different signal driving modes, and different scanning signals and data driving signals are introduced to the two adjacent domain areas respectively, then the two adjacent domain areas may be driven to be in different working states respectively through the scanning signals and the data driving signals. In this embodiment, since adjacent domain areas in the same sub-pixel have different power supply polarities, then the two adjacent domain areas in the sub-pixel adopt different polarity assignment modes. The multi-domain polarity assignment mode between domain areas can increase the charging rate of each of the sub-pixels. When the scanning signal is introduced to each of the sub-pixels, the different domain areas of the sub-pixel have specific charging efficiencies, so that the sub-pixels have sufficient charging rates, and the sub-pixels can combine different domain areas to emit a complete light source, thereby improving the large-angle display effect of the plurality of sub-pixels in the display panel, and improving the frame quality of the display panel.

In this embodiment, each of the sub-pixels is divided into several domain areas, and the domain areas in the sub-pixel are arranged as an array in both the vertical direction and the horizontal direction. Different domain areas are provided with different scanning control methods, and each of the domain areas emits a light source with corresponding color according to the scanning signal and the driving signal. Since the adjacent domain areas in the same sub-pixel have different polarities, then the plurality of domain areas in each of sub-pixels have different potentials, the sub-pixel may acquire light sources with different brightness by combining the plurality of domain areas, and the colors of the frame displayed by the plurality of sub-pixels are diversified, such that the display panel is provided with higher frame display quality. Further, the scanning signal and the data driving signal may be introduced to each of the domain areas, and the working state of the domain area may be controlled through the scanning signal and the data driving signal, and each of the sub-pixels in the pixel driving circuit may achieve different light-emitting states by adjusting the working states of the plurality of domain areas in the same sub-pixel, such that the control and flexibility of each of the sub-pixel is better, thereby facilitating the large-angle display control among the plurality of sub-pixels in the display panel.

In this embodiment, the driving circuit 40 may generates the scanning signals and data driving signals with different electrical levels, and make the plurality of sub-pixels in the display panel turned on sequentially by combining the scanning signals and the data driving signals, to further realize their own charging. The plurality of sub-pixels in the display panel are cyclically scanned and driven, and the plurality of sub-pixels emit corresponding light sources to display a more complete frame and dynamic frames, thus the pixel driving circuit in this embodiment has a relatively simple circuit structure and excellent control effect.

As an alternative implementation, M in this embodiment is an even number.

Each of the sub-pixels includes an even number of domain areas, and the corresponding domain areas in each of the sub-pixels may be charged separately by the scanning signal and the data driving signal, so that all domain areas in the sub-pixel have a uniform charging rate. Therefore, the even number of domain areas in this embodiment makes electric energy distribution of each of the sub-pixels more uniform, and the charging rates of the sub-pixels be better, thereby improving the practical value of the pixel driving circuit.

As an alternative implementation, the sub-pixel in this embodiment may include 2 or 3 domain areas, and the light-emitting state of each of the sub-pixels may be changed through the plurality of domain areas, so as to realize an optimal control effect for the sub-pixels in this embodiment. Alternatively, the technician may set the number of domain areas in each of the sub-pixels according to actual needs, and the sub-pixels in this embodiment can realize the multi-domain potential assignment mode and have excellent compatibility.

In combination with the above description, in this embodiment, through changing the spatial layout of each of the sub-pixels, dividing each of the sub-pixels into at least two domain areas, and separately controlling the working states of adjacent domain areas in each of the sub-pixels by the scanning signals and the data driving signals, the adjacent domain areas in the sub-pixel adopt different signal polarity assignment modes, then each of the sub-pixels has good controllable performance, and each of the domain areas can achieve a best charging rate through the scanning signal and the data driving signal, so as to overcome the problem of insufficient charging rate of sub-pixels in the display panel. At the same time, in this embodiment, by using the configuration rule of the domain areas of two sub-pixels with the same color in the vertical direction, corresponding domain areas of the sub-pixels with the same color in the same group of pixels are connected to the same scan wire G, and the working states of the plurality of domain areas of the sub-pixels with the same color can be simultaneously controlled by one scanning signal, which saves the number of the scan wires G, greatly reduces the cost for scanning and controlling the plurality of sub-pixels, and simplifies the circuit structure of the pixel driving circuit. The sub-pixels in the display panel can be sequentially turned on and charged through the scanning signals and the data driving signals, thereby ensuring that the display panel can present a complete frame. Therefore, in this embodiment, different polarity charging methods for adjacent domain areas in the sub-pixels are realized by using the scanning signals and the data driving signals, thus the quality of large-angle frames of the plurality of sub-pixels is greatly improved, and the user's visual experience is improved. Consequently, the problems in the exemplary technologies, that each of the sub-pixels in the display panel has insufficient charging rate which in turn leads to poor large-angle display quality of the display panel, and the cost for scanning and controlling each of the sub-pixels in the display panel is relatively high, and the user's experience is poor, are effectively solved.

As an alternative implementation, FIG. 3 shows another pixel driving circuit provided in an embodiment. As shown in FIG. 3, the driving circuit 40 includes a controller 401, a gate driver 402, and a source driver 403.

Regarding the controller 401, the controller 401 generates a control signal.

In this embodiment, the working states of the gate driver 402 and the source driver 403 may be controlled by the control signal, thereby adjusting the light-emitting state of each of the sub-pixels in the display panel. The controller 401 has functions of signal generation and signal conversion. Alternatively, the technician can transmit an operation instruction to the controller 401, and then the controller 401 generates the corresponding control signal according to the operation instruction. The light-emitting state of each of the sub-pixels in the display panel may be adjusted through the control signal to meet visual needs of the technician.

As an alternative implementation, the controller 401 may be implemented by a single-chip microcomputer or CPLD (Complex Programmable Logic Device) in the exemplary technologies. Exemplarily, the controller 401 may be implemented by a single-chip microcomputer, the single-chip microcomputer may be the STC89C52 series. Because the single-chip microcomputer has complete functions and good expandability, therefore in this embodiment, the working state of each of the sub-pixels in the display panel can be controlled in real time through the controller 401, thereby achieving high flexibility and improving the practical value of the pixel driving circuit in this embodiment.

Regarding the gate driver 402, the gate driver 402 is connected between the controller 401 and the scan wires G, and the gate driver 402 generates the scanning signals according to the control signal.

In this embodiment, the controller 401 outputs the control signal to the gate driver 402 to drive the gate driver 402 to generate the scanning signals, and the gate driver 402 outputs the scanning signals to the scan wires G. The scanning signals can control the on state or the off state of each of the sub-pixels in the display panel, therefore in the this embodiment, the scanning and driving process of the sub-pixels in the display panel can be controlled through the gate driver 402, which is easy to operate. Alternatively, the gate driver 402 in this embodiment may be implemented by using the gate driving circuit in the exemplary technologies, where the gate driving circuit includes electronic components such as a transistor and a resistor. The working state of the gate driving circuit may be changed by controlling the transistor to turn on or turn off. Exemplary, when the transistor is turned on, the gate driving circuit generates a corresponding scanning signal, and then the scanning signal may start the scanning and driving process of the display panel, thus the display panel can display complete and dynamic images/videos. Therefore, in this embodiment, the high-frequency scanning process of the plurality of sub-pixels in the display panel can be achieved by the gate driving circuit, which ensures safe and stable operations of the sub-pixels in the display panel.

Regarding the source driver 403, the source driver 403 is connected between the controller 401 and the data wires D, and the source driver 403 generates data driving signals according to the control signal.

In an embodiment, the controller 401 outputs the control signal to the source driver 403, and the working state of the source driver 403 may be changed by the control signal. The source driver 403 can realize functions of video information conversion and transmission, and the data driving signals may be output to the data wires D through the source driver 403, and the data driving signal includes image data. When the sub-pixels in the display panel receive the data driving signals, the sub-pixels display corresponding images/videos according to the data driving signals, therefore the data driving signals generated by the source driver 403 can change the display state of the frames in the display panel to meet the visual requirements of the user.

As an alternative implementation, the source driver 403 may be implemented by a source driver circuit in the exemplary technologies. The source driver circuit includes a MOS tube array, and the MOS tube array includes a plurality of MOS tubes arranged in an array, and the MOS tube array generates the corresponding data driving signals according to a DC power supply, and the data driving signal is used as a transmission medium of the image data. The data driving signals may be continuously introduced to the sub-pixels of the display panel to display complete and continuous images/videos, thereby ensuring normal display effect of the frames in the display panel.

In the pixel driving circuit as shown in FIG. 3, the driving circuit 40 can realize the scanning and driving process of each of the sub-pixels through three circuit components (the controller 401, the gate driver 402, and the source driver 403), which is simple and convenient to operate, and the plurality of sub-pixels can work together to display a more complete and clear frame through transmitting the image information to each of the domain areas in the sub-pixels by the scanning signals and the data driving signals. Therefore, the driving circuit 40 in this embodiment has a relatively simplified circuit structure, and the scanning and driving states of the sub-pixels are changed by the signal conversion function of the driving circuit 40, which is of extremely high practical value, and the scanning and driving process of the sub-pixels is provided with extremely high controllability.

As an alternative implementation, in the row direction, the polarities of any two adjacent domain areas are the same, and said two adjacent domain areas are located in different sub-pixels.

In this embodiment, two adjacent domain areas in different sub-pixels may be simultaneously controlled by the same data driving signal, and the light-emitting states of the two adjacent domain areas may be simultaneously controlled by the scanning signal and data driving signal, and any two adjacent domain areas are provided with the same polarity, which realizes the synchronous control mode of two adjacent sub-pixels in the row direction. On the basis of ensuring the charging rate of the sub-pixels, the cost for scanning and driving the plurality of sub-pixels in the row direction is reduced, such that the effect of the frames of the plurality of pixels is better.

As an alternative implementation, in the row direction, any two adjacent domain areas are connected to the same scan wire G, and said any two adjacent domain areas are located in different sub-pixels.

Exemplarily, taking FIG. 2 as an example, for the first sub-pixel and the second sub-pixel in the first row of sub-pixels, the domain area 32 is adjacent to the domain area 33, and the domain area 32 and the domain area 33 are connected to the same scan wire G1, and the light-emitting states of the domain area 32 and the domain area 33 may be controlled at the same time through one scanning signal. In this embodiment, in the same way, the working states of corresponding domain areas in two adjacent sub-pixels may be simultaneously controlled through one scanning signal, such that the scanning and driving cost for the sub-pixels in the horizontal direction is reduced, the domain areas between different sub-pixels is provided with higher coordination, and the large-angle display effect of the plurality of sub-pixels in the display panel is improved.

As an alternative implementation, in the pixel driving circuit, any two sub-pixels have the same number of domain areas. Therefore, in this embodiment, all sub-pixels in the pixel driving circuit have good controllability performance, and the scanning signals and the data driving signals achieve the best control effect for the plurality of sub-pixels. All the sub-pixels in the display panel serve as a whole capable of achieving the best frame display effect, and the different sub-pixels in the pixel driving circuit are provided with excellent coordination and controllability.

As an alternative implementation, in the horizontal direction, any two adjacent data wires D are provided with different power supply polarities. Since there is the data driving signal in each of the data wires, the data driving signal can drive the domain area into the corresponding working state, so that the different domain areas in the sub-pixel can emit corresponding light sources. Therefore, when the data driving signals in adjacent data wires are provided with different power supply polarities, then the adjacent domain areas in the same sub-pixel are provided with different power polarities and different data driving signals are introduced to the adjacent domain areas in the same sub-pixel. The adjacent domain areas in the same sub-pixel are provided with different polarity charging methods, and the light-emitting state of each of the domain areas in the sub-pixels may be controlled through the data driving signal and scanning signal, so that the sub-pixels is provided with a normal frame display function, thereby improving the quality of large-angle displaying in the display panel.

As an alternative implementation, each of the sub-pixels further includes M switching tubes, each of the switching tubes is correspondingly connected to one domain area, and the domain area is connected to the data wire D and the scan wire G through the switching tube.

In the row direction, any two adjacent switching tubes are connected to the same data wire D, and said any two adjacent switching tubes are located in different sub-pixels.

In the row direction, any two adjacent switching tubes are connected to the same scan wire G, and said any two adjacent switching tubes are located in different sub-pixels.

As an alternative implementation, in the above sub-pixels, the switching tube is a field-effect transistor or a triode. A first conduction terminal of the switching tube is connected to the data wire D, a control terminal of the switching tube is connected to the scan wire G, and a second conduction terminal of the switching tube is connected to the domain area.

In this embodiment, when the scanning signal is introduced to the control terminal of the switching tube, the switching tube may be controlled to be turned on or off through the scanning signal, thereby changing the working state of each of the sub-pixels. Exemplarily, when the scanning signal is output to the control terminal of the switching tube through the scan wire G, the switching tube is turned on by the scanning signal, and the first conduction terminal and the second conduction terminal of the switching tube are directly connected, such that the data wires output the data driving signals to the domain areas through the switching tubes, and the domain areas emit corresponding light sources according to the data driving signals. In the same way, the data driving signals may be introduced to different domain areas in the same sub-pixel respectively to realize the frame/video display function of the sub-pixels. Therefore, in this embodiment, all sub-pixels can work together in cooperation to dynamically display complete frames.

As an alternative implementation, the switching tube is a MOS tube. As shown in FIG. 2, the gate of the MOS tube is connected to the scan wire G, the source of the MOS tube is connected to the domain area, and the drain of the MOS tube is connected to the data wire D, and The MOS tube may be controlled to be turned on or turned off by the scanning signal on the scan wire G. When the scanning signal is at different electrical levels, the MOS tube is turned on or off under the drive of the scanning signal. Exemplarily, when the MOS tube is turned on by the scanning signal, the drain and source of the MOS tube are directly turned on, and the data driving signal is output to the domain area through the MOS tube, and then the domain area is driven to emit the corresponding light source, and all domain areas in the sub-pixels work in cooperation to display a complete and clear image/video. Therefore, in this embodiment, the working state of each of the domain areas in the sub-pixels may be controlled through the MOS tube, which is simple to operate and beneficial to simplify the circuit structure of the pixel driving circuit in this embodiment, making the circuit production cost lower. The working state of each of the domain areas in the sub-pixels may be driven by the scanning signal and data driving signal, so that the light sources in the sub-pixels are provided with good controllability, the overall frame effect of the plurality of sub-pixels in the display panel is improved, and the practical value of the pixel driving circuit is higher.

Therefore, in this embodiment, each of the sub-pixels is provided excellent control performance, and the working state of each of the domain areas may be controlled by turning on or off the switching tube, thus the control response speed is very good, and the compatibility is very strong.

As an alternative implementation, in the same sub-pixel, the first domain area and the Mth domain area are connected to different scan wires G, and the first domain area and the Mth domain area are connected to different data wires D.

Exemplarily, taking the pixel driving circuit shown in FIG. 2 as an example, the first sub-pixel includes two domain areas: the domain area 31 and the domain area 32, the domain area 31 is connected to the data wire D1 and the scan wire G2, and the domain area 32 is connected to the data wire D2 and the scan wire G1, in this way different scanning signals and different data driving signals may be introduced to the domain area 31 and the domain area 32 respectively, so that the domain area 31 and the domain area 32 are in different working states. In the same way, in this embodiment, the first domain area and the last domain area in each of the sub-pixels adopt different signal driving methods, and different scanning signals and data driving signals can realize corresponding polarity charging methods for different domain areas in the same sub-pixel, thereby greatly improving the charging rates of the domain areas of the sub-pixels, achieving a better large-angle display effect of the plurality of the sub-pixels and improving the frame quality of the display panel.

As an alternative implementation, the sub-pixel is any one of a blue sub-pixel, a green sub-pixel, and a red sub-pixel.

In this embodiment, each of the sub-pixels may be any one of the three basic colors (red, green, and blue). When the scanning signals and the data driving signals are introduced to the sub-pixels, the scanning signals and the data driving signals may play a role of charging for corresponding sub-pixels to drive the sub-pixels to emit light sources with corresponding colors. The pixels may emit light sources with different color levels by combining the three basic colors, so that the plurality of pixels can present a more coordinated frame with colors, thereby improving the operability of the pixel driving circuit and ensuring the large-angle display quality of the frames.

As an alternatively implementation, in the pixel driving circuit, all sub-pixels in the same row are provided with the same color.

In this embodiment, the scanning and driving process of each of the domain areas in the sub-pixels may be realized by the scanning signals and the data driving signals, and the plurality of sub-pixels in the same row cooperate with each other to achieve corresponding light-emitting effects. Since adjacent sub-pixels in each row have the same color, so there is a lower color level difference between the light emitting effects achieved by the adjacent sub-pixels, which improves the quality of large-angle frames as well as coordination, and brings a better visual experience to the user.

As an alternative implementation, in the same pixel, any two of the sub-pixels have different colors.

In this embodiment, each pixel may achieve various light emitting effects through combining light sources with different colors, which improves the color diversity of each pixel in the pixel driving circuit, so that the pixels in this embodiment are provided with better controllability, and the pixel driving circuit has a wider scope of application and higher practical value.

As an alternative implementation, there are M scan wires G between any two rows of sub-pixels.

As an alternative implementation, there is one data wire D between any two columns of sub-pixels.

In this embodiment, the scan wires G and the data wires D are uniformly arranged in the pixel driving circuit. The scan signals and data signals can realize the scanning and driving process of the plurality of domain areas in each of the sub-pixels, which improves the scanning and driving efficiencies of the plurality of sub-pixels in this embodiment, so that the pixel driving circuit can be in a stable working state, and the circuit layout structure of the pixel driving circuit is simplified, the compatibility is better, thus the manufacturing cost and application cost of the pixel driving circuit is reduced.

As an alternative implementation, each of the sub-pixels includes: two domain areas and two switching tubes. In the row direction, there is one data wire D provided between any two adjacent sub-pixels. In the column direction, there are two scan wires G provided between any two adjacent sub-pixels.

Referring to the structure of the pixel driving circuit as shown in FIG. 2, each of the sub-pixels can achieve different light-emitting effects by combining two domain areas, that is, the internal structure of each of the sub-pixels is simplified, and the scanning and driving cost of the sub-pixels in the pixel driving circuit gets lower, and the controllability of the light sources in each of the sub-pixels is enhanced. The working states of two adjacent domain areas in the sub-pixel may be controlled respectively through the scanning signals and data driving signals, so that each sub-pixel can achieve complete light emitting effect, the display panel is provided with a better image/video display effect, and the overall coordination and control performances among the plurality of sub-pixels are better.

As an alternative implementation, in the same row of sub-pixels, the first domain areas of the sub-pixels are connected to one scan wire G through the switching tubes, and the second domain areas of the sub-pixels are connected to another scan wire G through the switching tube.

Therefore, in this embodiment, the light-emitting states of one row of sub-pixels may be controlled by the scanning signals in two scan wires G, and the coordination among the plurality of sub-pixels is excellent. In order to better illustrate rules of arrangement of the sub-pixels in the above embodiments, a specific example is used to illustrate the rules of spatial arrangement of the sub-pixels in conjunction with FIG. 2, which is as shown below.

In the pixel driving circuit as shown in FIG. 2, one data wire D is provided between any two adjacent columns of sub-pixels. Exemplarily, one data wire D2 is provided between the first column of sub-pixels 101 and the second column of sub-pixels 102, so that the data driving signals may be output to the sub-pixels in the two columns of sub-pixels (the first column of sub-pixels 101 and the second column of sub-pixels 102) through the data wire D2 to simultaneously drive the plurality of sub-pixels into the working states. Two scan wires G are provided for any two adjacent sub-pixels, exemplarily, two scan wires G2 and G3 are provided between the first row of sub-pixels 201 and the second row of sub-pixels 202, so that different scanning signals can be introduced to the domain areas of the sub-pixels in this embodiment, and the plurality of domain areas of the sub-pixels are provided with different polarity assignment modes, thereby improving the light source controllability of the domain areas in each of the sub-pixels and improving the insufficient charging rates of the sub-pixels in the display panel.

In this embodiment, each of the sub-pixels includes two domain areas. Exemplarily, the first sub-pixel in the first column of sub-pixels as shown in FIG. 2 is taken as an example, where the first sub-pixel includes adjacent two domain areas: the domain area 31 and the domain area 32. In the same say, as shown in FIG. 2, each of the sub-pixels achieves a complete frame display effect by combining two domain areas, which is helpful to simplify the circuit structure of the pixel driving circuit in this embodiment.

In the structure of the pixel driving circuit as shown in FIG. 2, in the same row of sub-pixels, the corresponding domain areas in the sub-pixels are connected to one scan wire G in order to introduce the same scan signal. In this embodiment, the working states of the plurality of sub-pixels in the same row may be changed at the same time through one scanning signal. Taking the first row of sub-pixels 201 in FIG. 2 as an example, in the first row of sub-pixels 201, each of the sub-pixels includes two domain areas, for example, the first sub-pixel includes the first domain area 31 and the second domain area 32, the second sub-pixel includes the second domain area 33 and the first domain area 34, and so on. Moreover, for all the sub-pixels in the same row, the corresponding domain areas of the sub-pixels are connected to the same scan wire G. The first row of sub-pixels 201 in FIG. 2 is taken as an example, the first domain areas of all sub-pixels in the first row of sub-pixels 201 include: 31, 34, 35, 38, and 39, and the first domain areas of all sub-pixels in the first row of sub-pixels 201 are connected to the same scan wire G2 through the switching tubes, so that the first domain areas of all sub-pixels in the first row of sub-pixels 201 may be controlled to be turned on or off through one scan signal. In the same way, the second domain areas of all sub-pixels in the first row of sub-pixels 201 include: 32, 33, 36, 37, and 40, and the second domain areas of all the sub-pixels in the first row of sub-pixels 201 are connected to another scan wire G1 through the switching tubes. Since there are different scan signals in the scan wire G1 and the scan wire G2, therefore in this embodiment, the light-emitting states of all domain areas in the first row of sub-pixels 201 may be controlled in real time through two scan wires (the scan wire G1 and the scan wire G2) in two channels, so that the plurality of sub-pixels in the display panel can form a whole to display a more complete and clear image/video, thereby increasing the charging rate of each of the sub-pixels, improving the large-angle display quality of the plurality of sub-pixels in the display panel, and reducing the scanning and driving cost of the sub-pixels in the display panel.

Therefore, according to the pixel driving circuit as shown in FIG. 2, the plurality of domain areas of each of the sub-pixels adopt different potential assignment modes, so that the plurality of sub-pixels present different polarity distributions and arrangements in space. When the scanning signal and the data driving signal are introduced to each of the domain areas in the sub-pixels, the charging rate of each of the sub-pixels can be increased, so that the plurality of sub-pixels in the display panel can present large-angle frames in a better quality, thereby bringing a good visual experience to the user. At the same time, in this embodiment, the working states of the plurality of domain areas may be simultaneously controlled through one data driving signal or one scanning signal, which realizes a coordinated control effect of different sub-pixels, reduces the number of lines in the pixel driving circuit, reduces the manufacturing cost of the pixel driving circuit in this embodiment, and simplifies the structure of the circuit, such that the sub-pixels in the display panel is provided with a lower scanning and driving cost but higher practical value.

As an alternatively implementation, regarding the sub-pixels of each row, all the sub-pixels have the same color. Taking FIG. 2 as an example, the first row of sub-pixels 201 is red, and the second row of sub-pixels 202 is green, in this way each row of sub-pixels has a specific color. Therefore, in the pixel driving circuit of this embodiment, the light-emitting states of each row of sub-pixels may be controlled in real time by the scanning signals and data driving signals, and the plurality of sub-pixels may cooperate with each other to show frames with different levels of color. Therefore, the sub-pixels in this embodiment not only are provided with a more simplified control method, but also the overall frames in the display panel is provided with better coordination and integrity, thus the pixel driving circuit has a wider application range.

As an alternative implementation, in the pixel driving circuit, in the same pixel, any two rows of sub-pixels have different colors, and the color of each of the sub-pixels is any one of red, green, and blue.

In this embodiment, one pixel may combine three basic colors (red, green, and blue) to display images/videos with different colors and brightness, the frames in the display panel show diversity, and the plurality of sub-pixels may be driven by the scanning signals and the data driving signals to achieve large-angle display, thereby improving the frame quality of the display panel, and bringing a good visual experience to the user. Exemplarily, in the same pixel, the colors of three sub-pixels adjacent in the column direction are red, green and blue respectively.

As an alternative implementation, each group of pixels includes two pixel groups arranged in an array in the column direction, and each of the pixel groups includes a first pixel group, a second pixel group, and a third pixel group. Each of the first pixel group, the second pixel group, and the third pixel group include one row of sub-pixels, and each row of the sub-pixels is connected to two scan wires G correspondingly.

In the same group of pixels, the jth domain area of the sub-pixels in the first pixel group of the previous pixel group and the jth domain area of the sub-pixels in the first pixel group of the next pixel group are connected to the same scan wire G.

In the same group of pixels, the jth domain area of the sub-pixels in the second pixel group of the previous pixel group and the jth domain area of the sub-pixels in the second pixel group of the next pixel group are connected to the same scan wire G.

In the same group of pixels, the jth domain area of the sub-pixels in the third pixel group of the previous pixel group and the jth domain area of the sub-pixels in the third pixel group of the next pixel group are connected to the same scan wire G.

In this embodiment, 1≤j≤2 and j is an integer.

Exemplarily, FIG. 4 shows a structure of another pixel driving circuit provided by an embodiment. As shown in FIG. 4, one group of pixels 30 includes a pixel group 501 and a pixel group 502, where the pixel group 501 includes a first pixel group 601, a second pixel group 602, and a third pixel group 603, and the pixel group 502 includes a first pixel group 604, a second pixel group 605, and a third pixel group 606. In this embodiment, the corresponding domain areas of the first pixel group 601 in the pixel group 501 and the corresponding domain areas of the first pixel group 604 in the pixel group 502 share one scan wire G, and then one scanning signal can realize scanning and driving for the two sub-pixel groups (including the first pixel group 601 in the pixel group 501 and the first pixel group 604 in the pixel group 502), so as to improve the coordination and control performance between different sub-pixel groups and reduce the scanning and driving cost of the plurality of domain areas. In the same way, the corresponding domain areas of the second pixel group 602 in the pixel group 501 and the corresponding domain areas of the second pixel group 605 in the pixel group 502 share one scan wire G, and the corresponding domain areas of the third pixel group 603 in the pixel group 501 and the corresponding domain areas of the third pixel group 606 in the pixel group 502 share one scan wire G. Therefore, in this embodiment, each group of pixels is divided into two adjacent pixel groups, and each pixel group includes several sub-pixel groups, and the corresponding domain areas of the sub-pixel groups in different pixel groups share one scan wire G, thus the number of the scan wires Gin the pixel driving circuit is greatly reduced, and the sub-pixel groups with the same attributes in different pixel groups may be scanned and driven by one scan signal, so that the sub-pixels at different rows display corresponding images/videos under the drive of the same scan signal, and the display panel can present a complete frame with mixed colors.

As an alternative implementation, in the row direction, any two adjacent domain areas are provided with the same power polarity, and said any two adjacent domain areas are located in different sub-pixels.

Exemplarily, referring to FIG. 4, in the first row of sub-pixels, the domain area 32 is located in the first sub-pixel, the domain area 33 is located in the second sub-pixel, the domain area 32 is adjacent to the domain area 33, and the domain area 32 and the domain area 33 are provided with the same power polarity. In the same way, in the row direction, adjacent domain areas in different sub-pixels adopt the same signal driving mode.

In this embodiment, in the row direction, adjacent domain areas in different sub-pixels are connected to the same data wire D and to the same scan wire G, so that the domain areas in the two adjacent sub-pixels may be driven by the same data driving signal and the same scanning signal to be at a stable working state, which reduces the scanning and driving cost of the pixel driving circuit, improves the charging efficiency of the sub-pixels in this embodiment, improves insufficient charging rates of the sub-pixels in the display panel, and effectively improves the large-angle display quality of the display panel, therefore the user's visual experience is better.

As an alternative implementation, in the column direction, any two adjacent domain areas are connected to different scan wires G, and said any two adjacent domain areas are located in different sub-pixels.

Exemplarily, referring to FIG. 4, in the first column of sub-pixels, the domain area 31 is located in the first sub-pixel, the domain area 41 is located in the third sub-pixel, the domain area 31 is adjacent to the domain area 41 in the column direction, and the domain area 31 and the domain area 41 are connected to different scan wires G. In the same way, in the column direction, different scanning signals are introduced to adjacent domain areas in different sub-pixels, and the adjacent sub-pixels in the vertical direction may be controlled by different scanning signals to be in corresponding working states, therefore the light-emitting states of the sub-pixels in the display panel are provided with better controllability, and the frames in the display panel is provided with a better dynamic display effect.

An embodiment of the present application provides a pixel driving circuit, which includes a plurality of sub-pixels, at least 3M scan wires, at least two data wires, and a driving circuit.

Regarding the plurality of sub-pixels, the plurality of sub-pixels are regularly arranged into at least six rows and at least one column. At least three consecutive sub-pixels located in the same column constitute one pixel, and every two rows of pixels form one group, and each sub-pixel includes M domain areas.

Regarding the at least 3M scan wires, each row of sub-pixels corresponds to M scan wires, and in each group of pixels, the ith domain areas of the sub-pixels with the same color are connected to the same scan wire.

Regarding the at least two data wires, each column of sub-pixels is correspondingly connected to two data wires, and in the row direction, any two adjacent domain areas are connected to the same data wire, and the any two adjacent domain areas are located in different sub-pixels.

The driving circuit is connected to the scan wires and the data wires, outputs scan signals through the scan wires to sequentially control each of the sub-pixels in the same row to turn on, and outputs data driving signals through the data wires to charge the sub-pixels correspondingly connected to the data wires, such that the polarities of any two adjacent domain areas in the same sub-pixel are different.

In the row direction, the polarities of any two adjacent domain areas are the same, and the any two adjacent domain areas are located in different sub-pixels.

In the row direction, any two adjacent domain areas are connected to the same scan wire, and the any two adjacent domain areas are located in different sub-pixels.

In the same sub-pixel, the first domain area and the Mth domain area are connected to different scan wires, and the first domain area and the Mth domain area are connected to different data wires.

Where M≥2, 1≤i≤M, and M and i are integers.

FIG. 5 shows a structure of the display device 70 provided by an embodiment. As shown in FIG. 5, the display device 70 includes a pixel driving circuit 701 and a display panel 702, where the pixel driving circuit 701 is electrically connected to the display panel 702, and a frame display state of the display panel 702 is changed by the driving circuit 701.

The pixel driving circuit 701 includes a plurality of sub-pixels, at least 3M scan wires, at least two data wires, and a driving circuit.

Regarding the plurality of sub-pixels, the plurality of sub-pixels are regularly arranged into at least six rows and at least one column. At least three consecutive sub-pixels located in the same column constitute one pixel, and every two rows of pixels form one group, and each sub-pixel includes M domain areas.

Regarding the at least 3M scan wires, each row of sub-pixels corresponds to M scan wires, and in each group of pixels, the ith domain areas of the sub-pixels with the same color are connected to the same scan wire.

Regarding the at least two data wires, each column of sub-pixels is correspondingly connected to two data wires, and in the row direction, any two adjacent domain areas are connected to the same data wire, and the any two adjacent domain areas are located in different sub-pixels.

The driving circuit is connected to the scan wires and the data wires, outputs scan signals through the scan wires to sequentially control each of the sub-pixels in the same row to turn on, and outputs data driving signals through the data wires to charge the sub-pixels correspondingly connected to the data wires, such that the polarities of any two adjacent domain areas in the same sub-pixel are different.

Where M≥2, 1≤i≤M, and M and i are integers.

Referring to FIGS. 1 to 4, the data driving signals are introduced through the data wires D of the pixel driving circuit 701, and the scan signals are introduced through the scan wires G of the pixel drive circuit 701, and the sub-pixels in the pixel driving circuit 701 may be driven by the data driving signals and the scanning signals to realize the function of displaying normal images/videos. According to the above description, in the pixel driving circuit 701, each sub-pixel includes a plurality of domain areas, and the domain areas in each of the sub-pixels are charged by using different polarities, so that the problem of insufficient charging rate of each of the sub-pixels is solved, and different domain areas in each of the sub-pixels adopt different potential assignment modes, which greatly improves the large-angle display effect of the mix-color frames of the plurality of sub-pixels. When the display device 70 in this embodiment is used in different industrial fields, the clarity and integrity of the frames in the display panel can be greatly improved, thereby bringing a good visual experience to the user. Therefore, the display device 70 in this embodiment can be widely applied to different types of industrial products, which has a wide range of applications, a low production cost, and strong practical value. Thus, the problem, that the charging rates of the sub-pixels of the display device in the traditional technology are insufficient so that the large-angle display effect of the display panel is poor, is effectively solved.

To sum up, the pixel driving circuit in the present application adopts a design of a plurality of domain areas of the sub-pixels, and the plurality of sub-pixels are presented with a specific rule of spatial arrangement, and the domain areas in each of the sub-pixels are provided with different polarity assignment modes, thus the charging rate of each of the sub-pixels in the display panel is improved, the scanning and controlling cost of the plurality of sub-pixels is reduced, and the large-angle display effect of the display panel is improved, thereby bringing the user with a good visual experience. Therefore, the pixel driving circuit in the present application has extremely important positive significance for the development of display panels, the frame display effect of the display panel can meet the needs of users, so the pixel driving circuit in the present application has important industrial production value.

The above description only describes alternative embodiments of the application, and is not used to limit the present application. For those skilled in the art, the present application may have various modifications and changes, and any modification, equivalent replacement, improvement, etc. made within the spirit and principle of the present application should be included in the scope of the claims of the present application.

What is claimed is:

1. A pixel driving circuit, comprising:
a plurality of sub-pixels regularly arranged into at least six rows and at least one column, wherein at least three consecutive sub-pixels located in the same column constitute one pixel, each two rows of pixels form one group, and each of the sub-pixels comprises M domains area;
at least 3M scan wires, wherein each row of the sub-pixels is correspondingly connected to M scan wires, and ith domain areas of the sub-pixels with the same color in each group of pixels are connected to the same scan wire;
at least two data wires, wherein each column of the sub-pixels is correspondingly connected to two data wires, any two adjacent domain areas in a row direction are connected to the same data wire, and the any two adjacent domain areas in the row direction are located in different sub-pixels; and
a driving circuit connected to the scan wires and the data wires, wherein the driving circuit is configured to output a scan signal through the scan wire to sequentially control each of the sub-pixels in the same row to turn on, and further configured to output a data driving signal through the data wire to charge the sub-pixels corresponding to the data wire, so that polarities of any two adjacent domain areas in the same sub-pixel are different;
wherein M≥2, 1≤i≤M, and M and i are integers.

2. The pixel driving circuit according to claim 1, wherein the polarities of any two adjacent domain areas in the row direction are the same, and the any two adjacent domain areas are located in different sub-pixels.

3. The pixel driving circuit according to claim 2, wherein the any two adjacent domain areas in the row direction are connected to the same scan wire, and the any two adjacent domain areas are located in different sub-pixels.

4. The pixel driving circuit according to claim 3, wherein each of the sub-pixels further comprises M switching tubes, each of the switching tubes is connected to corresponding one domain area, and the domain areas are connected to the data wires and the scan wires through the switching tubes; wherein
any two adjacent switching tubes in the row direction are connected to the same data wire, and the any two adjacent switching tubes are located in different sub-pixels;
the any two adjacent switching tubes in the row direction are connected to the same scan wire, and the any two adjacent switching tubes are located in different sub-pixels.

5. The pixel driving circuit according to claim 4, wherein the switching tubes are field-effect transistors or triodes;
wherein a first conduction terminal of the switching tube is connected to the data wire, a control terminal of the switching tube is connected to the scan wire, and a second conduction terminal of the switching tube is connected to the domain area.

6. The pixel driving circuit according to claim 1, wherein a first domain area and a Mth domain area in the same sub-pixel are connected to different scan wires, and the first domain area and the Mth domain area are connected to different data wires.

7. The pixel driving circuit according to claim 1, wherein the driving circuit comprises:
a controller generating a control signal;
a gate driver connected between the controller and the scan wire and generating the scan signal according to the control signal; and
a source driver connected between the controller and the data wire and generating the data driving signal.

8. The pixel driving circuit according to claim 1, wherein the sub-pixel is any one of a blue sub-pixel, a green sub-pixel, and a red sub-pixel.

9. The pixel driving circuit according to claim 1, wherein all the sub-pixels in the same row are provided with the same color.

10. The pixel driving circuit according to claim 1, wherein any two of the sub-pixels in the same pixel have different colors.

11. The pixel driving circuit according to claim 1, wherein any two adjacent data wires are provided with different power polarities.

12. The pixel driving circuit according to claim 1, wherein there are M scan wires provided between any two rows of sub-pixels, and there is one data wire provided between any two columns of sub-pixels.

13. The pixel driving circuit according to claim 1, wherein any two of the sub-pixels have the same number of domain areas.

14. The pixel driving circuit according to claim 1, wherein each of the sub-pixels comprises:
two domain areas and two switching tubes;
wherein there is one data wire provided between any two adjacent sub-pixels in the row direction;
there are two scan wires provided between any two adjacent sub-pixels in a column direction.

15. The pixel driving circuit according to claim 14, wherein,
first domain areas of the sub-pixels in the same row of sub-pixels are commonly connected to one scan wire through the switching tubes, and second domain areas of the sub-pixels in the same row of sub-pixels are commonly connected to another scan wire through the switching tubes.

16. The pixel driving circuit according to claim 14, wherein each group of pixels comprises two pixel groups arranged in an array in the column direction, each of the pixel groups comprises a first pixel group, a second pixel group, and a third pixel group, and each of the first pixel group, the second pixel group, and the third pixel group comprises one row of sub-pixels, and each row of the sub-pixels is correspondingly connected to two scan wires;
in the same group of pixels, jth domain areas of the sub-pixels in the first pixel group of the previous pixel group and jth domain areas of the sub-pixels in the first pixel group of the next pixel group are connected to the same scan wire;
in the same group of pixels, jth domain areas of the sub-pixels in the second pixel group of the previous pixel group and jth domain areas of the sub-pixels in the second pixel group of the next pixel group are connected to the same scan wire;
in the same group of pixels, jth domain areas of the sub-pixels in the third pixel group of the previous pixel group and jth domain areas of the sub-pixels in the third pixel group of the next pixel group are connected to the same scan wire;
wherein 1≤j≤2 and j is an integer.

17. The pixel driving circuit according to claim 14, wherein any two adjacent domain areas in the row direction are provided with the same power polarity, and the any two adjacent domain areas in the row direction are located in different sub-pixels.

18. The pixel driving circuit according to claim 1, wherein the M is an even number.

19. A pixel driving circuit, comprising:
a plurality of sub-pixels regularly arranged into at least six rows and at least one column, wherein at least three consecutive sub-pixels located in the same column constitute one pixel, each two rows of pixels form one group, and each of the sub-pixels comprises M domains area;
at least 3M scan wires, wherein each row of the sub-pixels is correspondingly connected to M scan wires, and ith domain areas of the sub-pixels with the same color in each group of pixels are connected to the same scan wire;
at least two data wires, wherein each column of the sub-pixels is correspondingly connected to two data wires, any two adjacent domain areas in a row direction are connected to the same data wire, and the any two adjacent domain areas in the row direction are located in different sub-pixels; and
a driving circuit connected to the scan wires and the data wires, wherein the driving circuit is configured to output a scan signal through the scan wire to sequentially control each of the sub-pixels in the same row to turn on, and further configured to output a data driving signal through the data wire to charge the sub-pixels corresponding to the data wire, so that polarities of any two adjacent domain areas in the same sub-pixel are different;
wherein polarities of any two adjacent domain areas in the row direction are the same, and the any two adjacent domain areas in the row direction are located in different sub-pixels;
wherein any two adjacent domain areas in the row direction are connected to the same scan wire, and the any two adjacent domain areas in the row direction are located in different sub-pixels;
wherein a first domain area and a Mth domain area in the same sub-pixel are connected to different scan wires, and the first domain area and the Mth domain area in the same sub-pixel are connected to different data wires;
wherein M≥2, 1≤i≤M, and M and i are integers.

20. A display device, comprising a pixel driving circuit and a display panel,
wherein the pixel driving circuit is electrically connected to the display panel, and a frame display state of the display panel is changed by the pixel driving circuit;
wherein the pixel driving circuit comprises:
a plurality of sub-pixels regularly arranged into at least six rows and at least one column, wherein at least three consecutive sub-pixels located in the same column constitute one pixel, each two rows of pixels form one group, and each of the sub-pixels comprises M domains area;
at least 3M scan wires, wherein each row of the sub-pixels is correspondingly connected to M scan wires, and ith domain areas of the sub-pixels with the same color in each group of pixels are connected to the same scan wire;
at least two data wires, wherein each column of the sub-pixels is correspondingly connected to two data wires, any two adjacent domain areas in a row direction are connected to the same data wire, and the any two adjacent domain areas in the row direction are located in different sub-pixels; and
a driving circuit connected to the scan wires and the data wires, wherein the driving circuit is configured to output a scan signal through the scan wire to sequentially control each of the sub-pixels in the same row to turn on, and further configured to output a data driving signal through the data wire to charge the sub-pixels corresponding to the data wire, so that polarities of any two adjacent domain areas in the same sub-pixel are different;
wherein M≥2, 1≤i≤M and M and i are integers.
